(19) United States
(12) Patent Application Publication
(10) Pub. No.: US 2018/0114457 A1
(43) Pub. Date: Apr. 26, 2018

(54) SYSTEM AND METHOD FOR IMPLEMENTING STANDARDIZED TESTS

(71) Applicant: Pinnacle Neuropsychological Systems, LLC, Fort Gratiot, MI (US)

(72) Inventors: Philip C. Liethen, Fort Gratiot, MI (US); John E. Meyers, Nokomis, FL (US)

(73) Assignee: Pinnacle Neuropsychological Systems, LLC, Fort Gratiot, MI (US)

(21) Appl. No.: 15/789,517

(22) Filed: Oct. 20, 2017

Related U.S. Application Data
(60) Provisional application No. 62/410,573, filed on Oct. 20, 2016.

(51) Int. Cl. G09B 7/02; G09B 7/06; G06F 17/30

(52) U.S. Cl. CPC G09B 7/02; G06F 17/30091; G06F 17/30076; G09B 7/06

(57) ABSTRACT

A system for administering a test through an application is described. The system includes a non-transitory computer readable medium and a microprocessor. The microprocessor is configured to execute instructions stored on the non-transitory computer readable medium. The system further includes a first output device that is coupled to the microprocessor and configured to provide output information, and a first input device coupled to the microprocessor and configured to receive input information. The microprocessor is further configured to output a test list, access a selected test, output an instruction from the selected test, output a first prompt, receive a first response, determine a first response time, establish a first score, and create a dataset.

### BACKGROUND

Standardized tests, including psychometric tests, employ a standard procedure: an examinee (e.g., a patient, student, employee) is either asked a question or shown an image to respond to and an examiner records the examinee's response, including how long it took the examinee to respond (“response latency”), applying a metric score to the response, and recording the score. Commonly, psychometric tests are administered by showing examinee an image to respond to, or question to answer, which the examiner must write down on paper while simultaneously juggling a stopwatch to observe and record response-time, as well as manipulating tests stimuli. Furthermore, the examiner administers more than one type of test, having to carry and organize a multitude of physical test documents. The standard administration of such tests is burdensome, often taking a considerate amount of time to complete. Such tests are subject to human error, leading to less accurate result.

### SUMMARY

This section provides a general summary of the present disclosure and is not a comprehensive disclosure of its full scope or all of its features, aspects, and objectives.

Disclosed herein are implementations of a system for administering a test. The system includes a non-transitory computer readable medium and a microprocessor. The microprocessor is configured to execute instructions stored on the non-transitory computer readable medium. The system further includes a first output device that is coupled to the microprocessor and configured to provide output information, and a first input device coupled to the microprocessor and configured to receive input information. The microprocessor is further configured to output a test list, access a selected test, output an instruction from the selected test, output a first prompt, receive a first response, determine a first response time, establish a first score, and create a dataset.

Also disclosed herein are implementations of a method for administering a test. The method includes outputting a test list interface, receiving a selected test file from the user interface, and accessing the selected file. The method further includes outputting instructions, outputting a prompt, receiving a response to the prompt, determining a response time, and scoring the response. The method further includes creating a dataset.

Also disclosed herein are further implementations of a system for administering a test. The system includes a computing device having a microprocessor, a storage medium for storing a test, data, and an application. The system further includes a timer, an input device configured to provide input information into the application, a recording device configured to record a signal, a first output device configured to provide a first output toward a first direction, and a second output device configured to provide a second output toward a second direction. The microprocessor is configured to access the test from the application from the storage medium. The microprocessor is further configured to output a test list having a test file for selection to the first output device, access a selected test based on the input information, output an instruction from the selected test to the first input device, output a first prompt to the second output device, receive a first response, determine a first response time from the timer, establish a first score, and create a dataset.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram showing an example of a hardware configuration of the system in accordance with one aspect of the present disclosure;

FIG. 2 is an illustration showing an example of a user interface for the application in accordance with one aspect of the present disclosure;

FIG. 3 is a flow chart showing an example of a process for implementing standardized tests and evaluating the responses and response time to provide and store test results in accordance with one aspect of the present disclosure;

FIG. 4 is a flow chart showing an example of a process for implementing standardized tests in accordance with one aspect of the present disclosure;

FIG. 5 is an illustration showing an example of a biographies screen in accordance with one aspect of the present disclosure;

FIG. 6 is an illustration showing an example of a forced choice screen in accordance with one aspect of the present disclosure;

FIG. 7 is an illustration showing an example of an auditory verbal learning test in accordance with one aspect of the present disclosure;

FIG. 8 is an illustration showing an example of a fluency test in accordance with one aspect of the present disclosure;

FIG. 9 is an illustration showing an example of a test dataset in accordance with one aspect of the present disclosure; and

FIG. 10 is an illustration showing an example of an alternate embodiment of the user interface shown in FIG. 2.

### DETAILED DESCRIPTION

The following description is merely exemplary in nature and is not intended to limit the disclosure in its application or uses. For purposes of clarity, the same reference numbers are used in the description and drawings to identify similar elements.

This disclosure relates to implementing standardized tests and evaluating the responses and response time to provide and store test results. This disclosure provides a central platform for administering standardized tests, such as interviews and psychometric tests, and collects responses, notations, and response latency. The terms “document” and “test” are used interchangeably in this disclosure. The terms “patient” and “examinee” are used interchangeably in this disclosure. The terms “administrator,” “examiner,” and “user” are used interchangeably in this disclosure. The terms “application” and “program” are used interchangeably in this disclosure. The term “display” and “output” may be used interchangeably in this disclosure. The terms “memory” and “storage” are used interchangeably in this disclosure. The terms “stimuli” and “prompt” are used interchangeably in this disclosure. The terms “interfuse” and “module” are used interchangeably in this disclosure.

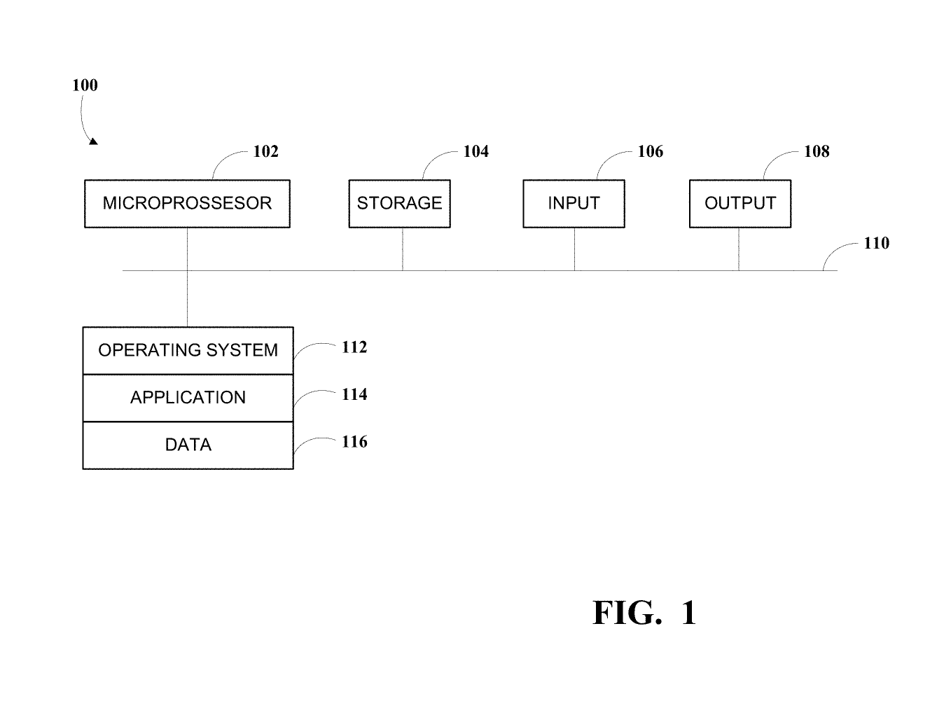

FIG. 1 is a block diagram depicting exemplary components of the system 100 in accordance with one aspect of the present disclosure. The system 100 may include additional and/or fewer components and is not limited to those illustrated in FIG. 1. The system 100 includes a CPU having a microprocessor 102, a storage 104 that may be accessed by the microprocessor 102, an input device 106, and an output device 108, wherein the input device 106 and the output device 108 are operatively coupled to the microprocessor 102 such that the microprocessor 102 may receive input information from and provide output information to the devices 106, 108, respectively.

The microprocessor 102 is a device that processes signals and performs general computing and arithmetic functions. The microprocessor 102 may include multiple single and multicore processors, co-processors, and architectures. The storage 104 may include a primary storage device or a secondary storage device. The primary storage device may include memory such as random access memory (RAM). The secondary storage device may be removable, internal, and/or external storage. Examples of secondary storage devices are magnetic storage devices, optical storage devices, flash memory devices, drives, network drives, and online and cloud storage. The microprocessor 102 and storage 104 are operatively coupled. The storage 104 stores an operating system 112, an application 114, and data 116. The data 116, for example, may be patient information, test files, stimuli, signals, output information, responses, response times, and scores. The application 114 is a computer program that performs coordinated functions, activities, or tasks in the form of computer executable program instructions that cause the microprocessor 102 to perform the methods described herein. The microprocessor 102 accesses the operating system 112, the application 114, and the data 116 using a bus 110.

The microprocessor 102 and the storage 104 communicate through the devices 106, 108. The input device 106 may be a mouse, gesture-sensitive input device, microphone, touchpad, touchscreen, webcam, or trackball. It should be appreciated that multiple input devices may be used simultaneously. The output device 108 is preferably a display device. The output device 108 may be a monitor, a projector, a printer, a speaker, headphones, and a haptic communication device, or similar device that allows output to be presented to a user. The system may have additional input or output devices that may be the same or difference devices as the

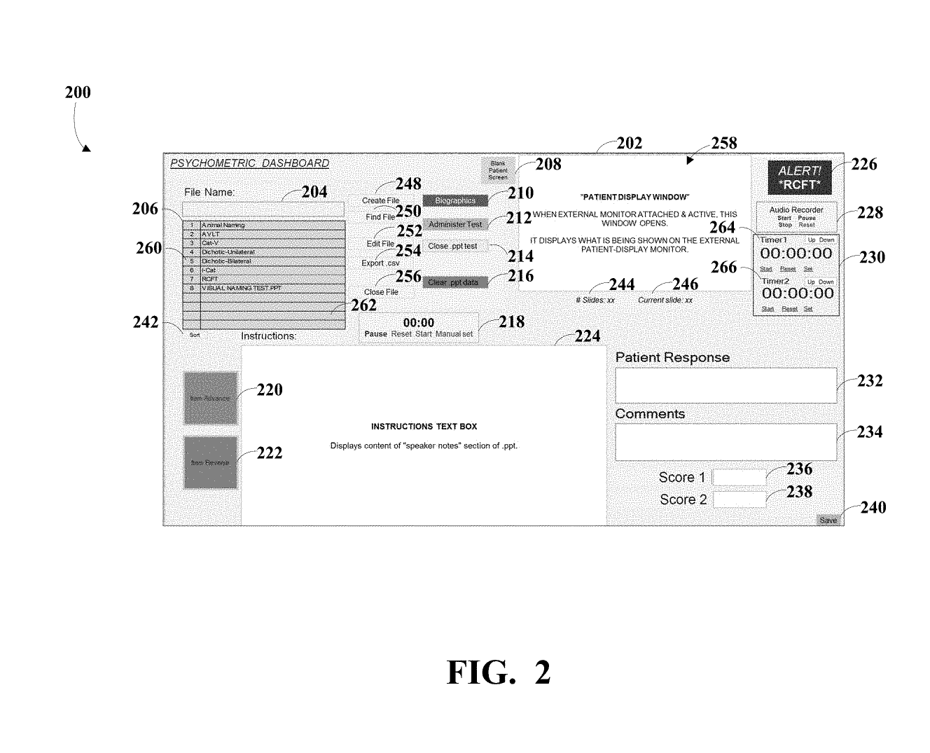

FIG. 2 is an illustration showing an example of a user interface 200 for administering a test. The user interface 200 includes a main screen 202 that is visible to the user using the output device 108. The main screen 202 displays file name text box 204 that allows the user to input text using the input device 106. Text, such as “File Name:” is located adjacent to the file name 204. The text may be omitted or displayed at another location.

The main screen 202 displays a test list interface 206 including at least one column having at least one test number 260 and test name 262 corresponding to a test stored on the storage 104. The test list interface 206 includes a sort button 242 configured to reorder the test names 262 when selected. The test name 262 or the test number 260 may be omitted from the user interface 200. The user may add, delete, or edit the tests listed in the test list interface 206. For example, the user may import a test or remove a test from the test list interface 206. The user may also renumber the list of tests or the names of the tests. The user may select a sort 242 to reorder the numbered documents in a numeric order, with non-numbered documents subsequently listed in alphabetical order after the numbered documents. The user may reorder the tests as-needed. Alternative sorting of the tests may be implemented. When the application 114 is opened, the test list interface 206 is populated from the storage 104 using the bus 110. The main screen 202 also displays a biographies button 210 and an administer test button 212. The user may use the input device 106 to select a test from the test list interface 206 and open the test by selecting the administer test button 212. The user may also enter a test number 260, enter a test name 262, or use an alternative selection method to select the test prior to selecting the administer test button 212. After a test is selected and administered, the test opens and the test becomes visible for the user to enter data 116.

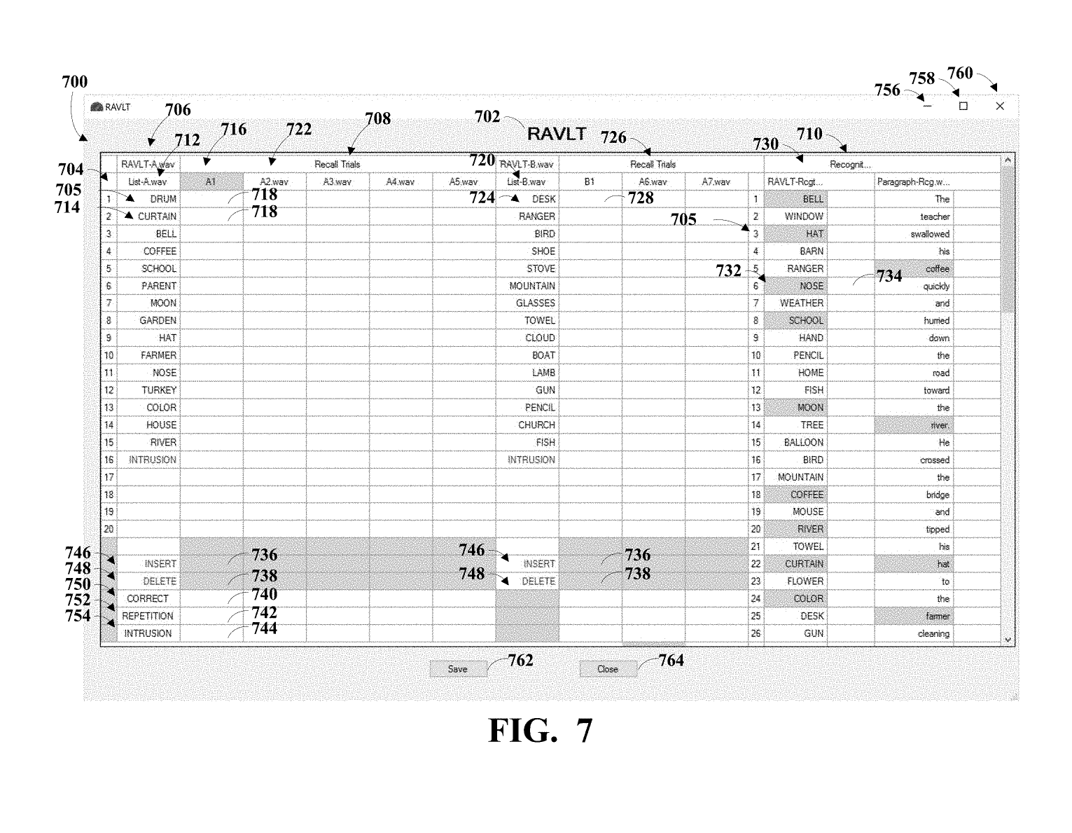

In one embodiment, open-source tests, such as neuropsychological tests, are built into the application 114 as pop-up test modules. Referring to FIG. 7, for example, an auditory verbal learning test 700 is built into the application as a pop-up test module. The auditory verbal learning test 700 includes a header 702 that includes text, such as “RAVLT” located towards the top of the auditory verbal learning test 700. The text may be omitted or displayed at another location from the header 702. The auditory verbal learning test 700 includes a form 704 having sections, such as a first list section 706, a first recall trial section 708, and a recognition section 710. The first list section 706 includes a first title cell 712 having a name of a first accompanying .wav file or verbal prompt, and at least one term 714 for outputting to an examinee via the first .wav file or prompt. The first recall trial section 708 includes columns, such as a response column 716 that receives responses 718 after outputting the first prompt and any subsequent prompts. A numbered column 705 is located adjacent to the terms 114 so that “1” corresponds to a first term in the first list section 706, and “2” corresponds to a second term in the first list section 706, etc. The first recall trial section 708 also includes at least one subsequent trial response column 722 that records the responses of subsequent trials of the first prompt and any subsequent prompts.

The auditory verbal learning test 700 may include one or more accompanying .wav files or verbal prompts, a second title cell 720, a second list section 724, and a second recall trial section 726 that receives responses 728 of subsequent trials of a second prompt or a series of prompts after the first recall trial section 708 has finished.

The recognition section 710 also includes a list of responses 730 that correspond to a selected or active trial For example, the application 114 determines which of the responses 718 and/or responses 728 may be inserted into the recognition section 710 in the list of responses 730. The number column 705 is also located adjacent to the second list section 724. The number column 705 may be located at alternative locations in application 114 or may be omitted. The recognition section 710 characterizes each response 732 within the list of responses 730 as one of a correct, a repetition, or an intrusion response. The recognition section 710 may include a column adjacent to list of responses 730 such that the each response 732 is accompanied by an indicator 734 of its characterization. The form 704 of the auditory verbal learning test 700 includes cells for receiving characterization information or a total number of characterized responses, such as insert 736, delete 738, correct 740, repetition 742, and intrusion 744 (collectively “characterization cells”), each of which is accompanied by text 746,748,750,752,754 corresponding to each cell. These characterization cells are terms of the art and the auditory verbal learning test 700 may include more and/or fewer characterization cells. The characterization cells receive and display the total number of responses that are characterized by the application 114. The auditory verbal learning test 700 includes a save button 762. The save button 762 is a function that, when selected, saves the data 116 from the test administration to the storage 104. The auditory verbal learning test 700 includes a close button 764 that, when selected, closes he auditory verbal learning test 700. If the user selects the close button 764 prior to selecting a save button 762, then the fluency test 800 closes without saving the data 116 inputted into the auditory verbal learning test 700, if applicable. The application 114 may display a prompt or screen to ask the user to confirm that the he auditory verbal learning test 700 should close without saving the data 116 before closing. The auditory verbal learning test 700 further includes a minimize button 756, a maximize button 758, and an exit button 760 that minimizes, maximizes, or exits the auditory verbal learning test 700 window, respectively when selected. If the exit button 760 is selected prior to saving the data 116, the application 114 may provide a prompt as explained for the close 764.

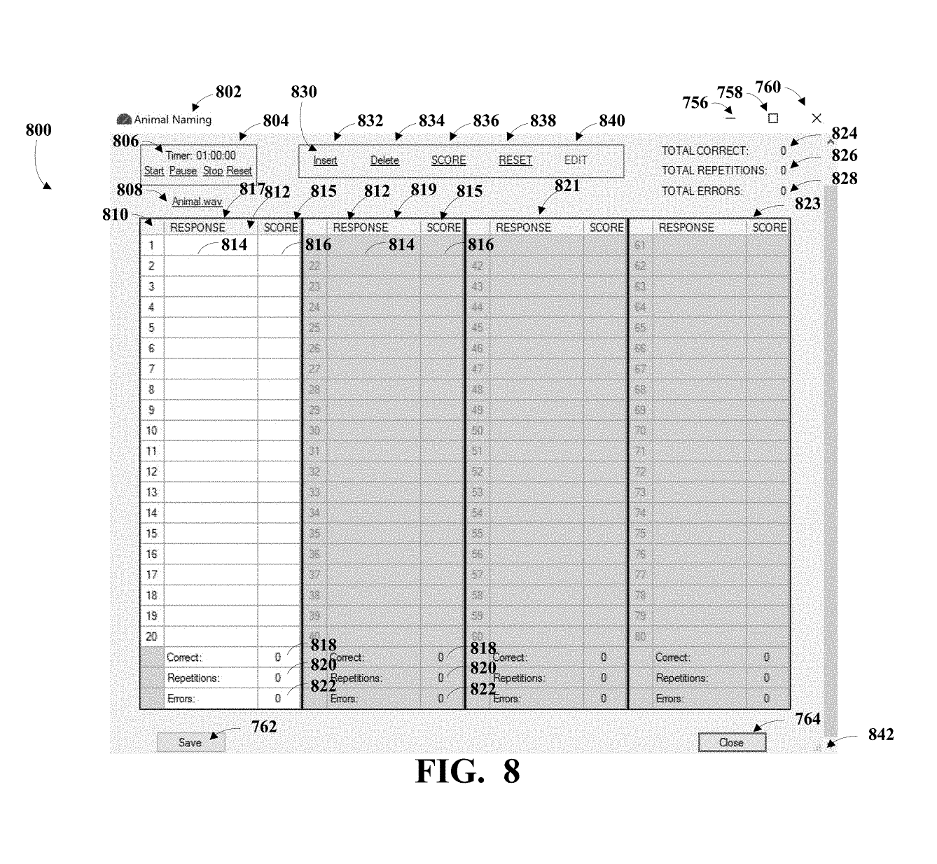

Referring to FIG. 8 illustrates another embodiment of a test built into the application 114 as a pop-up test module. A fluency test 800 uses a prompt to solicit responses from an examinee and inputs or receives responses during a time period. The time period may be predetermined or allow the user to select a time period. The microprocessor 102 is configured to determine if the response received is correct. The response may be entered using the input device 106 or another input device. The response may be automatically entered, for example, using an audio recording device, a video recording device, an image capturing device, facial recognition software, a motion sensor, or another device. The fluency test 800 includes a header 802 that includes text corresponding to the specific fluency test name, such as “Animal Naming” located towards the top of the fluency test 800. The fluency test 800 includes a timer box 804 having a timer 806 that defaults to time-down from, for example, 1-minute. The timer box 804 also includes buttons that allow the user to start, pause, stop, and reset the timer 806. The fluency test 800 includes a file button 808 that displays a .wav file or another file type using software, such as a media player when selected. The fluency test 800 includes a form 810 having at least one section including a response column 812 configured to receive responses 814 and a score column 815 that assigns a score 816 to each response. The microprocessor 102 is configured to determine the category of each response and allocate a score based on the category of the response. For example, a score of “1” is allocated for a response categorized as correct, a score of “2” is allocated for a response categorized as repetition, or a score of “3” is allocated for a response categorized as an intrusion.

The fluency test 800 may have four sections 817, 819, 821, 823. During a first time period, a first section 817 is active. When a section is active, data 116 can be entered into the active section. When the first time period expires, the first section 817 becomes grayed out, the data 116 cannot be entered into the first section 817, and a second section 817 becomes active. This process continues until there are no more time periods in the fluency test 800. Each section 817, 819, 821, 823 includes a correct cell 818, a repetition cell 820, and an error cell 822 that determines and displays the number of responses that are characterized as such for each section 817, 819, 821, 823, respectively. When a time period ends, the timer 806 blinks “00:00” and all sections are grayed out. The fluency test 800 determines a total correct 824, total repetitions 826, and a total errors 828 that each displays the total number of responses that are characterized as such across all sections 817, 819, 821, 823. For example, the fluency test 800 is set to run for one minute total, with four sections 817, 819, 821, 823, each being active for a consecutive 15-second periods of time. The responses are input into the active section until the total time period runs out. The scores for sections 817, 819, 821, 823 are calculated individually in the cells 818, 820, 822 and displayed in each corresponding section. The total scores are determined and displayed in the cells 824, 826, 828, respectively. The data 116, which includes at least the individual scores and total score, can be saved as a dataset and/or exported.

The fluency test 800 further includes a settings box 830 having an insert button 832, a delete button 834, a score button 836, a reset button 838, and an edit button 840. The fluency test 800 includes the save button 762 and the save button 762 that function as described in FIG. 7. Likewise, the fluency test 800 includes a minimize button 756, a maximize button 758, and an exit button 760 that each have expected results on the fluency test 800 window.

In another embodiment, a test is a custom form or a user-created document. This disclosure provides versatility with its capacity for the user to set-up tests and questionnaires, using software such as Microsoft PowerPoint® (hereinafter PowerPoint). In one embodiment, the system 100 utilizes information from PowerPoint as follows. The system accesses the instructions and questions in a “speaker notes” section of PowerPoint or a comparable section of alternate software. The system uses a “control code” that is embedded in the speaker notes of a first slide of the user-created test to provide various capacities. Such capabilities may include whether a main screen timer 218 is to time-up or time-down, provide a starting point value, play audio files of instructions or test stimuli, dictate which slide is to display first, determine a length of time to display an image, and associate a slide with a value. The control code dictates how the test functions. For example, a first line is not displayed in the comment box 234. The microprocessor 102 reads the first line of text in the comment box 234 for the first slide and processes the settings. Images, stimuli, and prompts for the examinee to view are loaded into an area, such as the “image area” of the slide. Alternative configurations may be implemented. In addition, there are non-data slides that include a title page, an end page, pages that separate subtests, and any slides from which the system does not collect data.

The main screen 202 displays an instructions box 224. After the user selects a test from the test list interface 206 and opens the document or test, the instructions box 224 shows the user the task instructions that are loaded into a section, such as the speaker notes section of the user interface 200, and an associated slide image 1008 is displayed in a patient display window 258 of the main screen 202. The patient display window 258 may be located on the user interface 200 and/or a second output device 108. The slide image 1008 provides a stimulus or a prompt that may be characterized as a picture or questionnaire. The instructions box 224 may include slide bar functionality for scrolling. The text and images in the instructions box 224 may also be formatted. Text, such as “Instructions:” is located adjacent to the instructions box 224, however, the text may be omitted or changed.

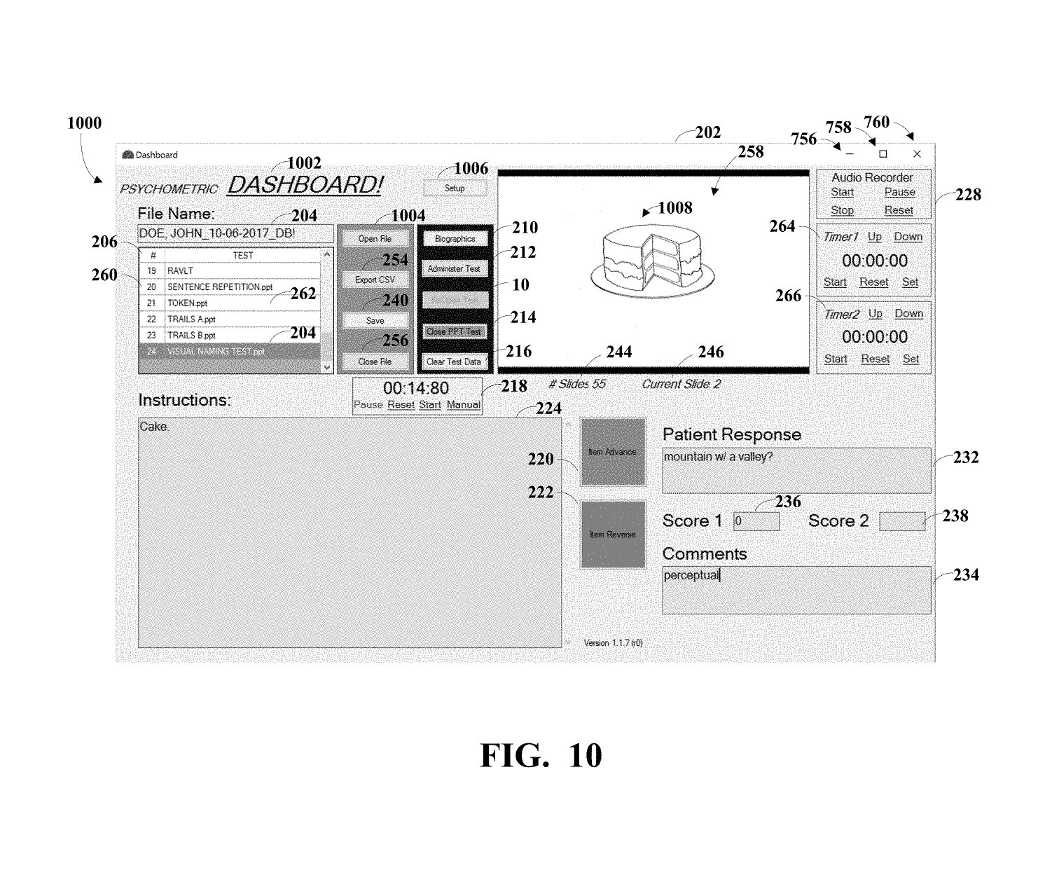

FIG. 10 illustrates a user interface 100 for a user-created test with features similar to the user interface 200. The first time a user-created test is opened in the application 114, the associated slide image 1008 opens in a window separate from the user interface 200 and may remain open as long as the application 114 is operating. The slide image may be configured to display on a second output device, such as output device 108. The second output device 108 may be oriented to provide an output to the examinee. The first output device and the second output device may be used interchangeably, or may be the same output device.

The main screen 202 displays the patient response box 232. The patient response box 232 is a text box for the user to enter text, such as narrative text relating to the test. In response to the stimulus, the examinee provides a response. When the examinee provides a response, the user or examiner enters the response into a patient response box 232. The response is entered using the input device 106, for example, by the examiner or even by the examinee. The response may be automatically entered, for example, using an audio recording device, a video recording device, an image capturing device, facial recognition software, a motion sensor, or another device. Content of patient response box 232 may be saved, edited, deleted, or exported, for example, to a .csv data file. Text, such as “Patient Response” is located adjacent to patient response box 232. The text may be omitted or changed.

When data 116 is entered into the test, the test name 262 in the test list interface 206 may be grayed out to indicate that the test has being administered and data 116 has been entered. Other graphics may be utilized to indicate the test being implemented. The test list interface 206 may include a scrolling bar functionality.

The main screen 202 displays the main screen timer 218. The main screen timer 218 is an ad hoc timer wherein the user may set the time. When the main screen timer 218 is selected, it opens in a separate window that overlays the main screen 202 but allows the underlying screen to remain active for input. When the main screen timer 218 is selected, a smaller timer window displays and floats on top of the active screen. The main screen timer 218 remains visible even when the underlying screen is selected. The main screen timer 218 includes controls, such as a start, stop, pause, reset, up, and down. If pause is selected, the main screen timer 218 blinks “pause” to prompt the user to start again. If reset is selected, the timer resets to a default state. If up is selected, the time increases. If down is selected, the time decreases and upon the expiration of the timer, i.e., at zero seconds, the main screen timer 218 blinks “00:00” until the user selects the main screen timer 218. Alternative text or numbers may be blinked or nothing blinked. The main screen timer 218 includes a close feature. The main screen timer 218 determines time accurately to the hundredths of seconds. Fewer, more, or alternative controls or functions may be implemented.

The main screen 202 displays a combined timer 230. The combined timer 230 includes a first timer 264 and a second timer 266, each with controls and functions of the main screen timer 218. The first timer 264 and the second timer 266 are positioned adjacent to each other. The functions may be different than the functions of the main screen timer 218. Fewer, more, or alternative controls or functions may be implemented.

The main screen 202 displays an item advance button 220. The item advance button 220 is a function associated with a test format, for example, with PowerPoint-type tests. In this example, when the user selects item advance button 220, the test advances to the next slide or function. The main screen timer 218 begins running after the item advance button 220 is selected and stops when a response is capture in patient response box 232 in order to capture the examinee's response time.

The main screen 202 also displays an item reverse button 222. The item reverse button 222 is a function associated with a test format, for example, with PowerPoint-type tests. In this example, when the user selects the item reverse button 222, the test advances to the previous slide or function. If the item reverse button 222 is selected, when the item advance 220 is subsequently used, it does not start the main screen timer 218. i.e., it does not over-write the previously established time value. The main screen timer 218 containing timer data from the previous slide may be displayed. The user may reset or start the main screen timer 218 after either the item advance 220 or the item reverse button 222 is selected.

The main screen 202 displays a total slides text 244. The total slides text 244 is the number of total slides or pages in the document. The main screen 202 displays a current slide text 246. The current slide text 246 is the document or page number of the document that is currently being displayed in the patient display window 258. The current slide 246 increases incrementally after the item advance button 220 is selected and decreases incrementally after the item reverse button 222 is selected. The total slides text 244 is adjacent to the current slide text 246, which are both adjacent to the patient display window 258. Alternative arrangements may be implemented. Text, such as “# Slides:” is located adjacent to the total slides text 244. Text, such as “Current slide:” is located adjacent to the current slide text 246. Such text may be omitted or displayed at another location.

The main screen 202 displays a first score box 236. The first score box 236 is a text box for the user to enter text, such as a numeric entry. A numeric value for the first score 236 may be entered by the user. Content of the first score box 236 may be saved, edited, deleted, or exported, for example, to the .csv data file. Text, such as “Score 1” is located adjacent to the first score 236. The text may be omitted or changed.

The main screen 202 displays a second score box 238. The second score box 238 is a text box for the user to enter text, such as a numeric entry. A numeric value for the second score 238 may be entered by the user. Content of the second score box 238 may be saved, edited, deleted, or exported, for example, to the .csv data file. Numeric values may be added until the test is complete. Text, such as “Score 2” is located adjacent to the second score box 238. The text may be omitted or changed.

The main screen 202 displays a comments box 234. The comments box 234 is a text box for the user to enter text, such as narrative text relating to the test, the examinee, or the examinee's response. Content of the comments box 234 may be saved, edited, deleted, or exported, for example, to the .csv data file. Text, such as “Comments” is located adjacent to the comment box 234. The text may be omitted or displayed at another location.

The main screen 202 displays an audio recorder 228. The audio recorder 228 is used for ad hoc recording. The audio recorder 228 includes various functions, for example, a start, pause, stop, and reset. When the audio recorder 228 is selected, a control window is displayed, which allows the user to select a function. If pause is selected, the audio recorder 228 blinks “pause” to prompt the user to start again. If stop is selected, the audio file is automatically saved to storage 104 in a patient data directory. An example saving and naming convention for the audio file is that the files saved are automatically named “Recording_01_xxxxxx”, where: “01” is the first such file created this date, with the second such ad hoc recording automatically named “02.” etc., and “xxxxxx” is the current date read from computer (e.g., Jul. 1, 2016 is shown as “070116”). Alternative storing and naming conventions may be implemented. When the reset is selected, the recorder resets, removing the current audio file from the audio recorder 228. After the reset is selected, the audio recorder 228 becomes available to record a new audio file. The audio recorder 228 may have a display indicator that the audio is being recorded, for example, a blinking light. The audio recorder 228 may also include a function to close. Another optional function is an audio playback control. When the audio playback control is selected, it opens in a separate window which overlays the active screen, but which allows the underlying screen to remain active for input. The audio playback control may display a light to indicate that it is functioning. The audio playback control also includes a close function. The features of the audio playback control may be changed.

Referring to FIG. 2, the main screen 202 displays a save button 240. The save button 240 is a function that, when selected, saves the data 116 from the test administration to storage 104. The data 116 may be saved into a document one or more times. Each subsequent time the user selects the save button 240, the data in the document over-writes the previous data in the document. The data 116 is saved to the storage 104 in the order in which the tests are administered. Alternative saving methods may be implemented.

The main screen 202 displays a create file 248. The create file 248 is a function that allows the user to create a document that may be edited, viewed, and implemented.

The main screen 202 displays a find file 250. The find file 250 is a function that allows the user to search the storage 104 for a specific or group of files. When the user selects the find file 250, a text box is displayed on display 108 that allows the user to enter text using input 106. After the user presses “enter,” selects “find,” or chooses a comparable alternative input, the system 100 searches for the desired file or files.

The main screen 202 displays an edit file button 252. The user may open a browser to a specified patient data file, which populates (he respective forms and allows editing of the data fields in the forms for both custom forms and user-created documents. The main screen 202 may substitute the edit file button 252 for an open file button 1004 that functions the same as the edit file button 252.

The main screen 202 displays a close file button 256. When the user selects the close file button 256, the data 116 is saved to the storage 104 and the current data file is closed. An exit button 760 may be available to close the main screen 202, wherein the data file is not saved to the storage 104.

The main screen 202 displays a close test button 214. The close test button 214 is a function that, when selected, closes the currently running test. A prompt is displayed that allows the user to select to save the test or not save the data 116 before the test closes. After the user makes a selection, the document closes. If the user selects to save the data 116, the data 116 from the test administration is saved to the storage 104 and the document name 262 is grayed out on the test list interface 206. If the user selects not to save the data 116, the data 116 from the test administration is not saved and the test name 262 is not grayed out on the document list interface 206. After the document closes, the main screen 202, the patient response box 232, and the output devices 108 becomes blank.

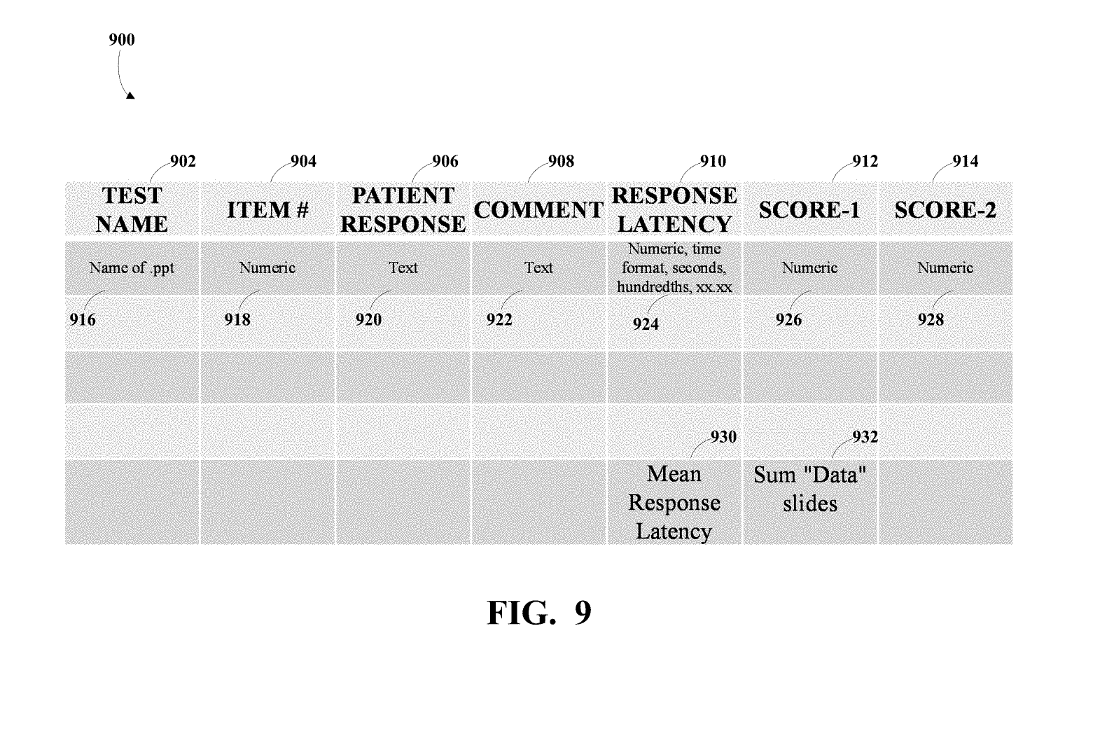

The main screen 202 displays an export file button 254. When the user selects the export file button 254, the data 116 is saved to the storage 104 in a specific file format, such as a .csv file format. The user may select the export file button 254 to bring up a window or prompt on output device 108. The window contains at least one option n to export the data 116. For example, the user may select an ALL-DATA.csv file or a MNS.csv file as described below, or a default data directory. The MNS file function is used to create the MNS.cvs file and names the saved file (he same as the original .cvs file but with an “MNS” included in the file name (e.g. “Doc. John_08-01-16_MNS”). Alternative text or saving methods may be used. Referring to FIG. 9, the .csv file may be displayed as data arranged in columns by using software such as Microsoft Excel®. As best shown in FIG. 9, when the data 116 is displayed as a spreadsheet 900, the spreadsheet 900 includes a list of columns with headers such as a test name 902, a prompt of an item 904, a patient response 906, a comment 908, a response latency 910, a first score 912, and a second score 914. The list of columns includes a test name 916 to display the name of the test file, a numeric value 918 that corresponds to a prompt or slide of the test, a response 920 from the patient that corresponds to the prompt, a comment text 922 corresponding to text retrieved from the comment box 234, a response time 924, a first score 926, and a second score 928, respectively. The spreadsheet 900 may further include a mean response latency 930 and a total score 932. The total score 932 may include the total score of one test or multiple tests. Multiple total scores may be included corresponding to total scores in numerous categories. The data 116 in the spreadsheet 900 may be saved as a file and/or exported. The spreadsheet 900 may include additional and/or fewer columns, rows, and/or information, and is not limited to those illustrated in FIG. 9.

The main screen 202 displays an alert 226. The alert 226 is activated by a control on a specified custom test screen. The alert 226 may show an alert named “ALERT! *RCFT*” or “ALERT! *AVLT*” or a blank screen, e.g., a blank box or a grayed box. Other alerts and text may be activated or displayed. Such specified custom lest screens have imbedded controls which contain text, for example, “Delay Timer,” which when selected, starts a countdown timer of a dictated length specified for the specific control. For example, the timer starts with a 30-minute. 3-minulc, or 1-minute countdown timer and “Alert! *RAVLT*” displays on the main screen 202 in the alert 226. Other start times may be implemented. When the main screen timer 218 runs out, the display flashes until the main screen timer 218 is selected, at which time, the main screen timer 218 resets. When the alert 226 is active, a blank screen appears in a box for the alert 226.

When alert 226 is triggered, e.g., by a specific timer timing-out, the text of alert 226 blinks. The text may be red text or text of another color. The alert 226 disappears after the user selects the alert 226 with the input 106. Selecting the blinking alert resets the alert 226. Other timers may be implemented.

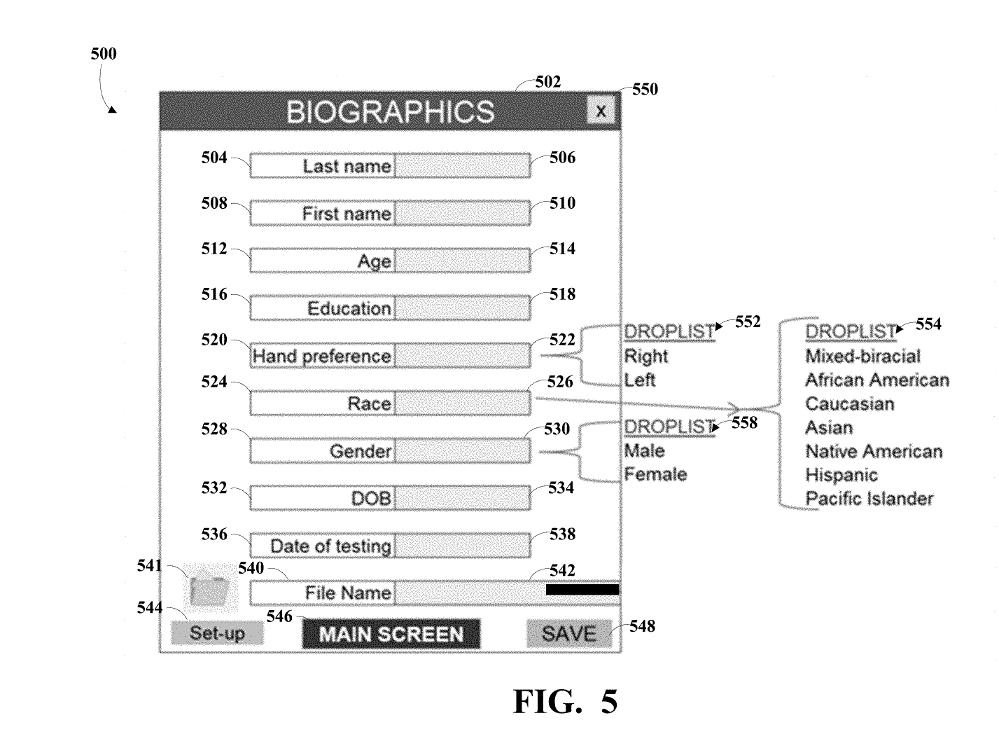

The main screen 202 displays a biographies button 210. When the user selects the biographies button 210, a biographies form 500 is displayed. An example of the biographies form 500 is shown in FIG. 5. The biographies form 500 includes a header 502 that includes text, such as “Biographies” located toward the top of the biographies form 500. The text may be omitted or displayed at another location from the header. The header 502 also includes a close button 550 that, when selected, closes the biographies form 500. The close button 550 may be located in an alternate location. If the user selects the close button 550 prior to selecting a save button 548, then the biographies form 500 closes without saving the data 116 inputted into the biographies form 500, if applicable. Alternatively, if the user selects the close button 550 prior to selecting the save button 548, a prompt may be displayed to ask the user if the biographies form 500 should be closed without saving the data 116. The user may then choose to save the data 116 or proceed without saving the data 116. This feature is optional and may be used in alternative embodiments. From the biographies form 500, the user may select additional functions, such as a set-up button 544 or a main screen 546. If the user selects the set-up button 544, the biographies form 500 closes and a set-up screen displays on the output device 108. Alternatively, the biographies screen is minimized or partially or fully hidden when the set-up screen is displayed and may be modified, edited, or saved at a later time. If the user selects the main screen 546, the biographies form 500 closes and the main screen 202 is displayed on output device 108. Alternatively, the biographies screen is minimized or partially or fully hidden when the main screen 202 is displayed and may be modified, edited, or saved at a later time. The biographies form 500 may close without saving the data 116 inputted into the biographies form 500 if the set-up button 544 or the main screen 546 is selected. Alternatively, if the user selects the set-up button 544 or the main screen 546 prior to selecting the save button 548, a prompt may be displayed to ask the user if the biographies form 500 should be closed without saving the data 116. This feature is optional and may be used in alternative embodiments. There may also be an auto-save feature that saves the data inputted into the biographies form 500 without the user selecting the save 548 after a certain period of time or if another function is selected.

The biographies form 500 also includes a list of fields, such as a last name 504, a first name 508, an age 512, an education 516, a hand preference 520. a race 524, a gender 528, a DOB 532, a date of testing 536, and a file name 540, with respective adjacent fields that the user may input information using the input 106. In this example, the user enters the examinee information as follows; a last name into a field 506, a first name into a field 510, an age into a field 514, an education into a field 518, a date of birth into a field 534, and a date of testing into a field 538. The user uses a drop-down list to select an option for the examinee as follows: a hand preference for a field 522 from a drop list 552 that includes right and left; a race for a field 526 from a drop list 554 that includes Mixed-biracial, African American, Caucasian, Asian, Native American, Hispanic, and Pacific Islander; and a gender for a field 530 from a drop list 558 that includes male and female. The hand preference 520 is the user's preferred hand for taking the test (e.g. the user using a dominant hand for inputting responses). Responses are input using input 106, such as a mouse, touchscreen, or touchpad and using a dominate versus non-dominant hand may affect the user's score. The file name 540 of the administered test is entered into a field

542. The user selects a document icon 541 for a file directory to find the test file. When the user selects the test document, the file name of the selected test document inserts into the field 542. The file name in the field 542 may be edited by the user. The file name may be auto-inserted from the file name 204. The fields included in biographics form 500 may be omitted or displayed at another location, edited, or added.

The fields may be text fields or drop-down lists, or a combination of both and the drop-down lists may include different options. The program may require that all of the information is completed by the user before proceeding (e.g. by selecting the set-up 544 or the main screen 546). Some or all of the information may be input automatically. The data 116 from the biographics form 500 may be saved in a file that may be accessed by the microprocessor 102 through the application 114 and inserted into the appropriate fields listed on the biographics form 500 for future tests for a particular examinee.

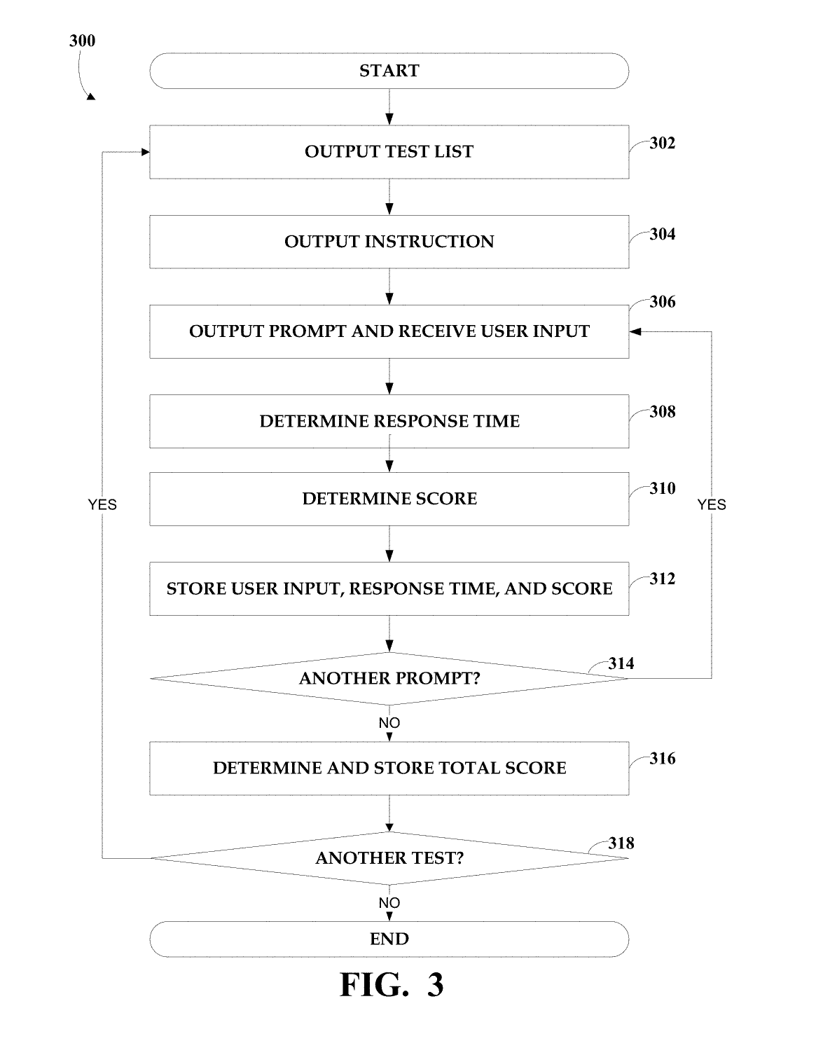

FIG. 3 is a flow chart showing an example of a process 300 for implementing standardized tests and evaluating the responses, response time, and relevant additional information, if necessary, to provide and store test results. The operations described in connection with the process 300 may be performed at one or more computers, such as the system 100. An operation is completed when it is performed by one computer. The operations with the process 300 may be a method or embodied as a non-transitory computer readable storage medium including program instructions executable by a processor that, when executed, causes the processor to perform one or more operations. The operations described with the process 300 may be stored at the storage 104 of the system 100 and may be executable by the microprocessor 102.

At least one test is stored at the storage system having the processor and a memory device for storing program instructions used by the processor. The test is stored by the storage system as an individual file that is able to be opened for viewing and editing.

At operation 302, the test list interface 206 is output. The test list interface 206 includes a test list of at least one test that corresponds to a test that is stored by the storage 104. The user selects a test using the input 106, such as a button, that causes usage of a selected test from the test list at an implementation system for viewing and response functions. The user may add, edit, or view the test list via the test list interface 206. The user may select the test by selecting the test name 262 followed by selecting the administer test 212 using the input 106.

At operation 304, a set of instructions is output in the instructions box 224. The instructions provide the user with test and user input information. The user or administrator may add, edit, or view the instructions. After the user selects a test from the at least one test in the test list interface 206 and opens the test, the instructions box 224 shows the user the task instructions that are loaded into a section, such as the speaker notes section of the spreadsheet, and the associated slide image is displayed in the patient display window 258 of the main screen 202, while simultaneously showing the image on the second output device 108 oriented toward the examinee.

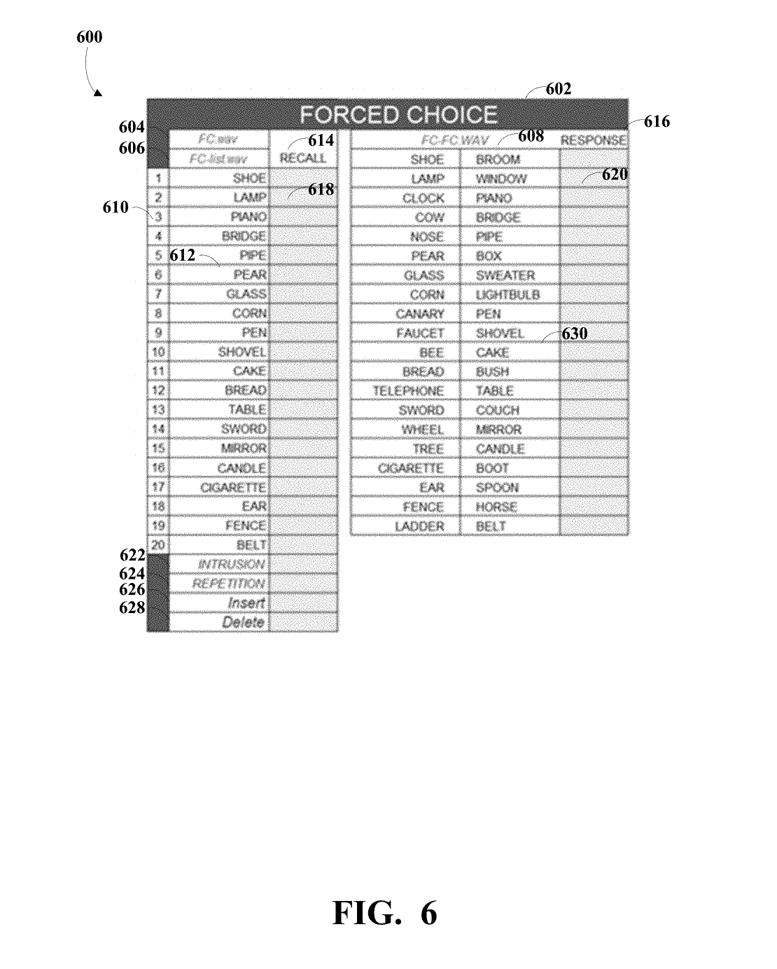

At operation 306, a first prompt to the user is output, wherein the prompt requests a first user input and the user inputs a first response, such as inputting the response into the patient response 232 using the input 106. The first response may be entered by inputting text or selecting from a list of choices, for example, from a forced choice screen 600 in FIG. 6. FIG. 6 shows an example of the forced choice screen 600. The forced choice screen 600 includes a header 602 that includes text, such as “Forced Choice” located toward the top of the forced choice screen 600. The text may be omitted or displayed at another location from the header. The forced choice screen 600 includes the types of test information displayed, including a FC 604, a FC-list 606, and a FC-FC 608. The FC 604 includes a list-learning task. The FC-list 606 includes a list, such as a Microsoft Word® list. The FC-FC 608 includes instructions for a forced-choice paradigm. A word or list of words, such as a word list 612 is displayed to a user and the user is prompted with a recall field 614 to input a response into a recall field 618 in connection with the FC 604 and the FC-list 606. The word list 612 is adjacent to a numbered list 610, for example numbers 1 to 20. The numbered list 610 is stored in storage 104 with the type of question. A word or list of words, such as a word list 630. is displayed to a user and the user is prompted with a response field 616 to input a response into a response field 620 in connection with the FC-FC 608. The examiner is provided with a list of control functions, such as an intrusion 622, a repetition 624, an insert 626, and a delete 628 that may be used to edit or clarify the examinee's response. When the intrusion 622 is selected, the word “intrusion” is inserted in red text in the recall field 618 or the response field 620 where a cursor resides. When the repetition 624 is selected, the word “repetition” is inserted in red text in the recall field 618 or the response field 620 where the cursor resides. The repetition 624 indicates that the patient repeated a word previously said. Text may be any color. When the insert 626 is selected, a cell is inserted at the cell where the cursor resides, and pushes down any cell entries below that cell so that a word may be entered. When the delete 628 is selected, a cell where the cursor resides is deleted and any cell entry below that cell is moved one position upward. One or more cells may be inserted or deleted at a time. The examiner identifies false positives, false negatives, true negatives, recalled but not recognized, and recognition and based on a chart, obtains a numerical value for each answered question. The data 116 includes at least the type of question, such as a forced choice, and a numerical value corresponding to the numbered list 610.

At operation 308. a determination is made regarding a response time based on the time difference between the first prompt displayed to the user and the user inputting the first response.

At operation 310, a determination is made regarding a first score based on the first response and the first response time. Other factors, including information from the biographies 210, is used to determine the first score, which is input into the first score 236.

At operation 312, the first response and the first score 236 are stored at the storage system, for example, at the storage 104.

At operation 314, a determination is made whether the test is complete or if there is another question or prompt. If there is another question or prompt, operations 306 through 314 are repeated until there is not another question or prompt. For example, a second prompt is output to the user, wherein the prompt requests a second user input and the user inputs a second response. A response time is then determined based on the time difference between the second prompt displayed to the user and the user inputting the second response. A determination is made regarding a second score based on the second response and the second response time. Other factors, including information from the biographies 210, is used to determine the second score, which is input into the second score 238. The second response and the second score 238 at the storage system. If there is not another question or prompt, the process proceeds to operation 316.

At operation 316, a total score is calculated, wherein the total score is the sum of the at least one score. For example, the total score is the sum of the first score and the second score. The total score is stored at the storage 104.

At operation 318, a determination is made whether another test is implemented. A completion prompt of the test is displayed to the user. If no other test will be implemented, the process ends. If another test will be implemented, the test list interface is output and the process proceeds to operation 302. The user, for example, may select whether another test should be implemented. This determination may also be automated.

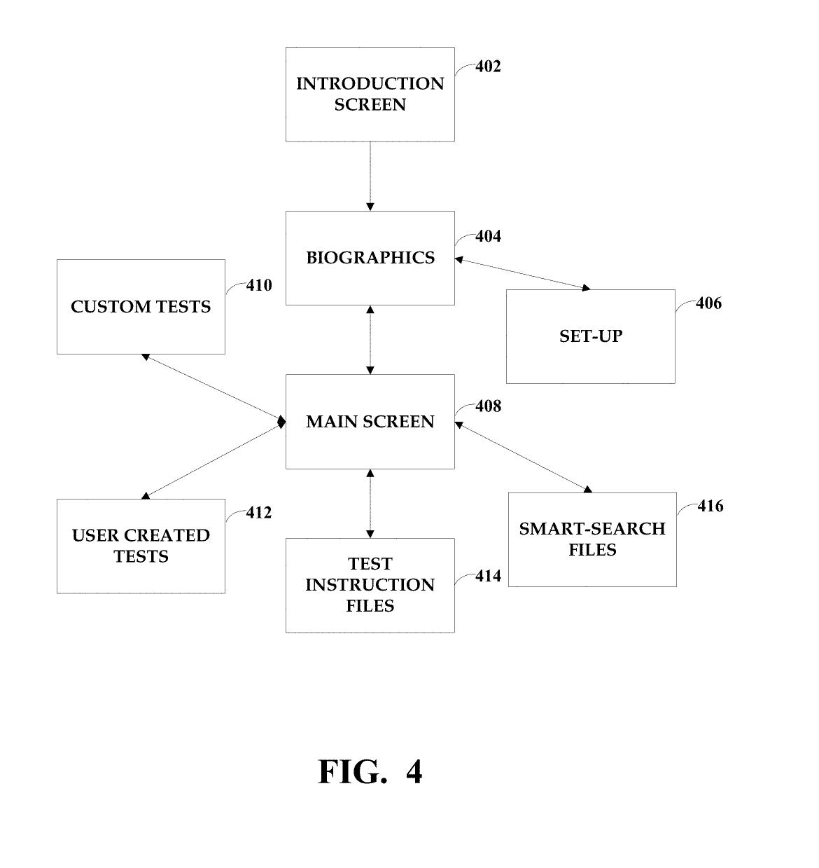

FIG. 4 is a flow chart showing an example of a process 400 for implementing standardized tests and evaluating the responses, response time, and relevant additional information, if necessary, to provide and store test results. The operations described in connection with the process 400 may be performed at one or more computers, such as the system 100. An operation is completed when it is performed by one computer. The operations with the process 400 may be a method or embodied as a non-transitory computer readable storage medium including program instructions executable by a processor that, when executed, causes the processor to perform one or more operations. The operations described with the process 400 may be stored at the storage 104 of the system 100 and may be executable by the microprocessor 102.

At least one test is stored at the storage system having the processor and a memory device for storing program instructions used by the processor. The test is stored by the storage system as an individual file that is able to be opened for viewing and editing.

At operation 402, an introductory screen is displayed on the main screen 202 of the user interface 200 on the output device 108 of the system 100. The introductory screen is displayed while the program loads. Text 1002, such as “Psychometric Dashboard,” is displayed on the introductory screen. The text 1002 may be omitted or displayed at another location. Images may also be displayed on the introductory screen. After the program loads, an extension screen opens and a biographics screen opens.

At operation 404. the biographics screen is displayed on the output device 108. The user may input information into the biographics screen. The user may select various controls located on the biographics screen, such as the save button 240, the close test button 214, a browser for browsing an existing data file to open, or to another screen. Additional or other controls may be implemented. From the biographics screen, the user may navigate to a set-up screen by selecting a set-up button 1006 to the main screen 202 by selecting either option.

At operation 406, the set-up screen is displayed on the output device 108. The user may input set-up information for the test. The user may return to the biographics screen when the set-up screen is closed. The information input into the set-up screen may be saved when the set-up screen is closed. The user may opt to not save the information.

At operation 408, the main screen 202 is displayed on the output device 108. The user may navigate back to the biographics screen or navigate to additional screens, such as a custom test screen or a user-created test screen.

At operation 410, a custom test screen is displayed on the output device 108. The user or administrator may edit, add, or delete tests from the custom test screen. The custom test screen is programmed to have custom structure defined in each respective test.

At operation 412, a user-created test screen is displayed on the output device 108. The user or administrator may edit, add, or delete tests from the user-created test screen. The user-created tests have a static structure for saving.

At operation 414, test instructions are displayed on the main screen 202 in the instructions box 224. The test instructions may be saved as a file, such as a .wav file and may be displayed using software, such as a media player.

At operation 416, a search feature is displayed on the main screen 202, wherein the user may use the application 114 to instruct the processor 102 to search the storage 104 for a specific document or groups of documents using the file name 204 or the document icon 541 as described herein.

The application 114 includes an upgrade feature in which the application 114 checks for upgrades each time the application 114 is initiated. The upgrade feature is optional and may have alternative implementations. The application 114 may require an activation code or alternative feature that must be input before the application 114 may run.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system for administering a test through an application, comprising:
a microprocessor, the microprocessor being configured to execute instructions stored on a non-transitory computer readable medium;
a first output device coupled to the microprocessor and configured to provide output information; and
a first input device coupled to the microprocessor and configured to receive input information;
wherein the microprocessor is further configured to:
output a test list;
access a selected test;
output an instruction from the selected test;
output a first prompt;
receive a first response;
determine a first response time;
establish a first score; and
create a dataset.

2. The system of claim 1, wherein the microprocessor is further configured to output a test list to the first output device;
receive input information from the first input device for accessing the selected test; and
output the instruction to the first output device.

3. The system of claim 1, wherein the system further comprises:
a second output device coupled to the microprocessor and configured to provide output information; and
a second input device coupled to the microprocessor and configured to receive the input information;
wherein the microprocessor is further configured to:
output a first prompt to the second input device;
receive a first response from the second input device; and
determine a second response time.

4. The system of claim 3, wherein the microprocessor is further configured to:
record the input information received from the second input device;
create an input file having the input information;
store the input file.

5. The system of claim 1, wherein the microprocessor is further configured to:
store the dataset;
create a new dataset; and
store the new dataset;

6. The system of claim 1, wherein the microprocessor is further configured to create the dataset in a file format of at least one of a CSV file, a text file, a XML file, and a PDF.

7. The system of claim 1, wherein the microprocessor is further configured to:
access data, the data including at least one of a text, multimedia, and template object.

8. The system of claim 7, wherein the microprocessor is further configured to:
output the data to the first output device;
create edited data, the edited data received from the input information; and
store the edited data.

9. The system of claim 1, wherein the microprocessor is further configured to determine a first category for the first response, the category including at least one of a correct, a repetition, an intrusion, and error.

10. The system of claim 9, the system further comprising:
a first column and a second column in the application, the first column and the second column being configured to receive input information;
wherein the microprocessor is further configured to:
determine a first time period;
add the first response into the first column during the first time period;
determine a first score based on the first category of the first response;
determine a second time period;
receive a second response;
add the second response into the second column during the second time period;
determine a second category for the second response; and
determine a second score based on the second category of the second response.

11. The system of claim 1, wherein the test is programmed within the application.

12. The system of claim 1, wherein the test is stored in a file format having at least one of a Power Point file, an XML file, a CSV file, an AVI file, a QuickTime file, a Windows Media Video file, a PDF file, and a MPEG file.

13. A method for administering a test, comprising:
outputting a test list interface having a test file for selection;
receiving a selected test file;
accessing the selected test file;
outputting an instruction from the selected test file;
outputting a first prompt from the selected test file;
receiving a first response;
determining a first response time;
establishing a first score; and
creating a dataset, wherein the dataset includes at least one of the first response, the first response time, and the first score.

14. The method of claim 13, further comprising:
receiving patient information;
storing patient information;
accessing patient information; and
editing patient information.

15. The method of claim 13, further comprising:
outputting a second prompt from the selected test file;
receiving a second response;
determining a second response time; and
establishing a second score.

16. The method of claim 15, further comprising determining a total score using the first score and the second score.

17. A system for administering a test, comprising:
a storage medium for storing a test, data, and an application;
a computing device having a microprocessor, the microprocessor configured to access the test from application from the storage medium;
a timer;
an input device configured to provide input information into the application;
a recording device configured to record a signal;
a first output device configured to provide a first output toward a first direction; and
a second output device configured to provide a second output toward a second direction;
wherein the microprocessor is further configured to:
output a test list having a test file for selection to the first output device;
access a selected test based on the input information;
output an instruction from the selected test to the first input device;
output a first prompt to the second output device;
receive a first response;
determine a first response time from the timer;
establish a first score; and
create a dataset.

18. The system of claim 17, wherein the input device includes at least one of a keyboard, a mouse, a gesture-sensitive input device, a microphone, an audio recorder, a video recorder, a touchscreen, a webcam, and a trackball.

19. The system of claim 17, wherein the first output device includes at least one of a monitor, a projector, a printer, a speaker, headphones, and a haptic communication device.

20. The system of claim 17, wherein the data includes at least one of patient information, the test file, the first prompt, the signal, the first output, the second output, the first response, the first response time, and the first score.
